(19) United States
(12) Patent Application Publication
(10) Pub. No.: US 2008/0057235 A1
(43) Pub. Date: Mar. 6, 2008

(54) Tubular Food Casing Having a Smoke-permeable Glued Seam

(76) Inventors: Jens FOEGLER, Taunusstein (DE); Herbert Gord, Ingelheim (DE); Michael Seelgen, Idstein (DE); Gert Bueker, Illingen (DE); Marion Bueker, Illingen (DE)

Correspondence Address: PROPAT, L.L.C., 425-C SOUTH SHARON AMITY ROAD, CHARLOTTE, NC, 28211-2841, US

(21) Appl. No.: 11/767,653

(22) Filed: Jun. 25, 2007

(30) Foreign Application Priority Data
Jun. 27, 2006 (DE) 10 2006 029400.9

(51) Int. Cl. B29D 23/00; B05D 7/22

(52) U.S. Cl. 428/34.8; 427/230

(57) ABSTRACT

A food casing is described with or without flat reinforcement insert and a smoke-permeable costing, preferably of protein, cellulose or acrylic. The insert is preferably a consolidated nonwoven or spunbonded nonwoven, a woven fabric, loop-formingly knitted fabric, laid fabric or loop-drawingly knitted fabric. The flat strip is glued to form a tube using a smoke-permeable gluing medium, preferably blood, plasma, protein, or other proteins. The food casing is preferably used as artificial sausage casing or cheese casing.

### CROSS-REFERENCE TO RELATED APPLICATIONS

This Application claims priority to its parent, German Patent Application No. 10 2006 029 400.9, filed Jun. 27, 2006 which is incorporated herein by reference in its entirety.

### BACKGROUND OF THE INVENTION

1. Field of the Invention

The invention relates to a smoke-permeable tubular food casing having a glued seam, a process for production thereof, and also its use as artificial sausage casing.

2. Description of the Related Art

Tubular food casings based on regenerated cellulose having an inner reinforcement of fibrous paper, in particular made of hemp fiber paper, have long been known (sec B.-A. Lang, G. Effenberger, Wursthüllen-Kunsidarm [Sausage casings—artificial skin], 3^{rd} Edition. [2006] Deutscher Fachverlag, Frankfort a.M., pages 51-54). They are generally used as artificial sausage casings and are usually also smoke permeable. These casings are made by the viscose process.

The amine oxide process was developed as an alternative to the viscose process. In this process the cellulose is no longer chemically derivatized, as in the viscose process, but purely physically dissolved in an aqueous amine oxide, in particular in N-methylmorpholine N-oxide (NMMO) monohydrate. The cellulose dissolved in the aqueous amine oxide can, as in the viscose process, be applied to a strip-shaped fibrous material formed to give a tube. The tube thus coated is then passed through various precipitation and wash baths. The precipitation bath, customarily contains dilute (i.e., about 10 to 20% by weight), aqueous amine oxide.

Textile-based artificial sausage casings are also known, for example made of circular-knitted cotton, which, is impregnated on the outside with collagen (DE-C 33 33 387).

In JP-A 51-079748, laminates are disclosed which are made of a porous, strip-shaped support material, for example made of paper, textile material or a porous film, and a film made of water-soluble polysaccharides, proteins and/or synthetic resins. Polysaccharides which are mentioned are, in particular, mannan, chitin, alginic acid, and pectin. As examples of proteins, collagen, gelatin and caseine are mentioned, as examples of synthetic resins, poly(vinyl alcohol), polyacrylic acid, polyacrylamide and polyvinylpyrrolidone. The laminates are processed, to give food casings, including also sausage casings. The casings exhibit an improved smokeability, high transparency and satisfactory strength. Laminates, however, frequently have the disadvantage that the adhesion between the individual layers is not sufficient.

In addition, casings are known in the production of which a strip-shaped flat material is shaped, to form a tube, the longitudinal edges of which, generally overlapping, are bonded to one another by generally known processes such as gluing, sealing, stitching.

For instance, EP 0 101 892 B1 discloses a sausage casing made of, if appropriate, fiber-reinforced cellulose which has a glued seam running along the longitudinal axis. The glued seam is produced using an adhesive which comprises a water-insoluble condensation product of polyamide-polyamine, aliphatic polyamine or polyamide having bifunctional halohydrins or derivatives thereof, such as epichlorohydrin. The adhesive layer can be prefabricated and transferred by a carrier bell having antiadhesive surfaces to the overlapping area of the cellulose strip shaped to form, a tube (DE 32 44 372 A1). Such a sausage casing is also smoke permeable in the region of the glued seam, but has the disadvantage tot the sausagemeat emulsion adhesion in the seam area is not identical to the sausagemeat emulsion adhesion at the sausage periphery.

The glued seam is frequently produced using a hot melt glue. A disadvantage of these hot melt glue seams is that they are not smoke permeable. After smoking, the surface color of the sausage below the glued seam is brighter than outside the glued area. A further disadvantage of the hot melt glued seam is that it is not transparent, even not after stuffing the casing with a fatty food.

### SUMMARY OF THE INVENTION

The object was therefore to develop a food casing which no longer has the advantages described. After smoking, the area of the food casing surface situated below the seam should not differ in color from the remaining areas, i.e., the seam should be permeable to cold smoke, warm smoke and hot smoke.

The object is achieved by gluing a coated or uncoated support material using an adhesive which contains 10 to 100% by weight of protein.

### DETAILED DESCRIPTION OF THE INVENTION

The present invention therefore relates to a smoke-permeable tubular food casing which, in the longitudinal direction, comprises a smoke-permeable glued seam which is generated from adhesive comprising 10 to 100% by weight, based on the dried casing, of protein. Preferably, the adhesive consists of up to 50 to 95% by weight, particularly preferably of 70 to 90% by weight, of protein, again in the dry state.

The base material for the food casing is a film-forming material which can be of natural, semisynthetic or folly synthetic origin. These include, in particular, proteins (such as collagen or gelatin), and in addition also cellulose, starch or starch derivatives (such as starch acetate) and poly(meth)acrylates. Preferably, use is made of proteins as film-forming material.

As agents for gluing, use is preferably made of blood plasma, collagen, gelatin, protein, casein (milk protein), soy protein, egg white, whey, gluten (wheal protein), zein (corn protein), ardein (peanut protein), pea protein, cottonseed, protein or fish protein, protein from mussels, algae, fungae or other biomaterials from marine creatures. Mixtures of said agents can also be used. In addition to the protein, the glue can contain other glues. The type and amount of additional glue must be dimensioned such that the smoke permeability and as far as possible also the transparency of the glued, seam, are not impaired. Such further glues are, for example, acrylic glues. A particularly strong glued seam is obtained when the proteins are additionally crosslinked, in particular by the action of UV radiation or by coagulation.

In addition to one or more protein(s), the adhesive can also contain fillers, such as also can be mixed with the film-forming materials.

The glued seam is virtually transparent, at least after stuffing the casing with a fatty food. Casings which are produced using said proteinaceous adhesive can be smoked in a known manner. They then exhibit over the entire periphery of the sausage a uniform smoke transfer to the surface. As a result, on the surface of a smoked sausage, no color difference can be observed between periphery and seam area.

The casing has a particularly high mechanical strength, when it additionally comprises a flat insert. The insert is generally coated with the film-forming material. The insert is preferably a consolidated nonwoven or spunbonded nonwoven which if appropriate is impregnated. Those which may be mentioned in particular are fiber papers, especially hemp fiber papers, which are given wet strength by impregnation with synthetic resins. By an impregnation, the adhesion to the film-forming material can also be improved.

A (further) one- or two-sided impregnation can be performed after application of the film-forming material to the flat insert, more precisely before or after the coated insert has been processed to form a tube. By means of this type of impregnation, for example the sausagemeat emulsion adhesion can be set or the mold resistance increased. The impregnation can also comprise transferrable color, aroma, odor and/or taste components (for example liquid smoke).

In further embodiments, she insert is a woven fabric, a loop-formingly knitted fabric, loop-drawingly knitted fabric or laid fabric or else a porous film. The flat insert can comprise natural and/or synthetic fibers. Preferred, materials are cotton, regenerated cellulose (viscose staple), silk, polyester, polyamide, polyolefin (in particular polypropylene), poly(vinyl acetate), polyacrylonitrile, poly(vinyl chloride) and also the corresponding copolymers. Also mixtures of various materials may be used (for example mixtures of viscose staple and polyester). All of these insert materials can be impregnated. An impregnation can be achieved, for example, by an adhesion promoter which improves the adhesion of the coating. The impregnating agents are used in a small amount, i.e., the amount is in no way sufficient to fill up the interspaces of the flat insert.

The expression “flat” is taken to mean materials which are relatively thin, but self-supporting, and may be shaped, with or without coating, to form, a tube. Thickness and weight per unit area of the flat insert are dependent on the later use of the casing. In general the weight per unit area is 3 to 1000 g/m² preferably 10 to 130 g/m², particularly preferably 12 to 75 g/m². If the flat insert is a fiber paper, this preferably has a weight of 17 to 29 g/m². Depending on requirements, the support material is more or less extensible or virtually not extensible. Non-extensible flat inserts are logical for casings in which particularly high constancy of caliber is of importance. If appropriate, the insert again comprises two or more layers of identical or different materials, for example a fiber paper which is bonded to a textile material.

The flat insert is coated on one side or both sides with one or more film-forming materials, with the resultant layer or coating being smoke permeable. Smoke-permeable coatings can be produced, for example, with protein, natural or synthetic polymers such as poly(meth)acrylates or cellulose. “Film-forming” means that the coating medium can form a continuous coherent coating.

Alternatively, the production of the casings or flat strips to be glued proceeds without support material. Here, mention may be made in particular of collagen and cellulose casings or flat materials.

Particularly preferred film-forming coating materials are proteins, such as gelatin or collagen. Those which are very suitable, however, are also casein (milk protein), soy protein, gluten (wheat protein), zein (corn protein), ardein (peanut protein), pea protein, cottonseed protein, or fish protein. The protein, in particular gelatin, is preferably mixed with an inorganic or organic filler. Particularly suitable inorganic fillers are in this case chalk, limestone flour, calcite, precipitated calcium carbonate, magnesium carbonate, barium carbonate, dolomite and/or other mixed carbonates. Particularly suitable organic fillers are finely ground cellulose powder, wheat bran, native and/or thermoplastic starch (TPS) and starch derivatives. In the range of non-derivatized starch, preference is given to native and/or thermoplasticized corn and/or potato starch. Starch derivatives are, for example, starch esters, such as starch acetates, maleates, propionates, butyrates, and/or nitrates, and/or oleates, starch xanthogenates, phosphates, sulfates and/or nitrates, starch ethers, such as starch methyl ether, ethyl ether, propyl ether, butyl ether, alkenyl ether, hydroxyethyl ether and/or hydroxypropyl ether, grafted starches, in particular starch grafted with, maleic or succinic anhydride and/or oxidized starches, such as dialdehyde starch, carboxymethyl starch and/or starch degraded by persulfate. Further polysaccharides can also be present, in particular plant powders and/or fibers such as, inter alia, those from cotton, kapok, flax, linen, hemp, jute, kenaf, ramie, sisal peat, straw, wheat, potatoes, tomatoes, carrots, coconut, pineapple, apples, oranges, figs, pines or cork.

However, it must be emphasized that the proteinaceous layer or coating does not contain regenerated or precipitated cellulose, but at any rate, in subsidiary amounts of less than 5% by weight, based on the weight of the layer or coating, can contain a finely distributed cellulosic filler.

Gelatin is isolated by hydrolyzing bones or hide protein (generally from cattle hide and bones), the triple-helical structure being largely destroyed. The molecular weight is about 15 000 to 250 000 g/mol, with the molecular weight distribution corresponding to a gaussian curve. Gelatin is substantially water-soluble.

The fraction of protein is generally 2.5 to 95% by weight, preferably 20 to 80% by weight, particularly preferably 30 to 75% by weight, in each case based on the total weight of the nonvolatile components of the casing, i.e., based on the dry weight.

In addition to the protein, the coating can contain, further natural, and/or synthetic polymers. These are, in particular, polyacrylates, poly(vinyl acetate)s and/or (co)polymers having units of vinyl acetate, wherein a greater or lesser part of the vinyl acetate units can also be saponified. These polymers can also have permanently plasticizing properties. Such compounds also acting as “primary plasticizer” are, for example, alginates, polyvinylpyrrolidones, quaternary vinyl pyrrolidone copolymers (GAFQUAT®), copolymers having mots of vinylpyrrolidone, maleic anhydride, methyl vinyl ether or branched polysaccharides (such as carrageenan). The fraction of further polymers is generally up to 50% by weight, preferably 5 to 40% by weight, particularly preferably 6 to 25% by weight, based on the dry weight of the casing.

If the film-forming protein is water-soluble, as is the case, for example, with collagen or gelatin, then in addition at least one cross-linker is required. Suitable crosslinkers are epoxidized linseed oil, diketenes having long-chain alkyl radicals (generally having (C₁₀-C₁₈)alkyl radicals), caramel, tannin, diepoxides, citral, aziridines, compounds having at least two carbaldehyde groups (such as glyoxal or glutaraldehyde) and/or polyamine-polyamide epichlorohydrin resins, acrylamides, bisacrylamides and methylol acrylic and also any desired, mixtures thereof, for example acrylamide methylol and bisacrylamide dimethylol. As a result of the crosslinking the water solubility of the film-forming protein is reduced or eliminated.

In addition, suitable compounds for coating smoke-permeable strips are acrylic resins and plastic blends, especially emulsion polymers based on (C₁-C₆)alkyl(meth)acrylates, in particular butyl(meth)acrylate. The expression (meth)acrylate here customarily means acrylate and/or methacrylate. Units of other monomers can occur, for example those of styrene, α-methylstyrene or vinyl acetate. Suitable acrylic resins are known to those skilled in the art. A further highly suitable coating medium is viscose, which is then subsequently regenerated to form cellulose.

Flat materials without supports may also be stuck together using the proteinaceous adhesive in such a manner that a smoke-permeable glued seam forms. Particularly preferred casings or flat materials are produced from cellulose or from proteins such as collagen.
The coating or the casing or flat strip can contain dye and/or pigments. The fraction of the dyes and/or pigments is in this case generally 0.5 to 12.0% by weight, preferably 1.0 to 6.0% by weight, in each case based on the dry weight of the casing.

If appropriate the casing additionally contains aroma substances, taste substances or odor substances which can be transferable to the sausagemeat emulsion. Those which may be mentioned here are, in particular, dry smoke or liquid smoke and also spices in solid or liquid form.

To prevent the casing from sticking together in the rolled up state, it can contain customary additives in subsidiary amounts (i.e., maximum about 10% by weight based on the dry weight of the casing). Such additives are, for example, aluminum silicates, in particular kaolin, calcium carbonate, silicon dioxide, a PVC pigment, waxes or fatty oils. Other additives can serve for ensuring the desired extent of sausagemeat emulsion adhesion. When the protein fraction is not sufficient for this, then customary internal impregnation must be performed, such as, for example, the formation comprising 40% of AQUAPEL® in order to achieve a release action.

If required, the casing according to the invention in addition contains at least one secondary plasticizer, preferably glycerol.

The thickness of the coating(s) is selected in such a manner that the casing has, for example, the water vapor permeability and oxygen permeability required for ripening the sausage. In general, the weight of the coating after drying is 10 to 200 g/m², preferably 20 to 120 g/m², particularly preferably 30 to 100 g/m².

The casing generally has a water content of about 4 to 20% by weight, preferably about 8 to 12% by weight. The casing of the invention can then be premoistened (to a moisture content of about 20 to 30% by weight) and delivered in this state to the sausage manufacturer, or be soaked by the sausage manufacturer himself before stuffing. Depending en the support material used, stuffing is also possible without soaking (for example textile support material).

The water vapor transmission rate (as specified in ISO 15106) is, in the casing of the invention, 50 to 2000 g/m²·d, preferably 200 to 1200 g/m²·d, and the oxygen permeability 30 to 1500 cm³/m²·d (determined as specified in ISO 7783-2 at 65% RH), measured on a 5 cm² size piece of the casing having a water content of 8 to 10% by weight and a plasticizer content of about 15% by weight. The water vapor transmission rate is in the range of about 10 to 100 l/m²·d, preferably 12 to 20 l/m²·d at 40 bar.

The extensibility of the casing is likewise determined by the type and thickness of the coating, in addition, however, by the type and weight per unit area of the reinforcing insert. For instance, the extension can vary between 0.1 and 25%, preferably between 1 and 5%, in each ease measured in the longitudinal and transverse direction, respectively.

Alternatively, flat materials which do not have a flat reinforcement insert can be stuck together. These are, in particular, flat materials based on cellulose or collagen.

Processes and devices for producing the casing of the invention are known to those skilled in the art.

If a reinforcing material is used, this can first be coated and then shaped to form a tube and glued, or vice versa.

In a preferred embodiment, the strip-shaped support material is coated on one or both sides, for example by spraying, doctorknife application, roll application, application using a wide slit nozzle or by other coating processes familiar to those skilled in the art. In this case the coating mix can be applied once or repeatedly. It is possible on each application to apply the same coating mix or various coating mixes. The casing obtained in the case of multiple application is termed a multilayer casing. The coated flat material is if appropriate printed. If required, the coated flat material is cut into strips of appropriate width. The strips are then formed into tubular casings using a forming shoulder, the longitudinal edges of which casings overlap to a greater or lesser extent. The overlapping region required in each case is also determined by the caliber. In general, it is relatively narrow and is 1 to 10 mm, preferably 3 to 6 mm. The overlapping longitudinal edges are charged with the glue by a suitable application system and stuck to one another. In the following process section, the reaction of the glue proceeds. The reaction of the glue can proceed in various manners. Particularly preferably, the reaction proceeds chemically, by drying or by denaturation of the protein. Protein denaturation expediently proceeds at a temperature of 55 to 100° C., preferably 65 to 90° C. In addition to the temperature, sufficient compression pressure in the adjoining section is required for strength of the glued seam. Gluing can in principle proceed even without the action of heat and pressure, but the life of the glued seam is then shorter.

In a preferred embodiment of the gluing of support materials which are coated with at least one film-forming protein, the glued seam, in addition to the smoke permeability, is also transparent. This has the advantage that on a sausage the glued seam is virtually invisible to the consumers, since periphery and glued seam have the same transparency.

A further advantage of the gluing described here compared with a seam glued by the hot-melt process is that mold growth is also possible on the glued seam. Mold growth in the seam region is in this case virtually identical to the mold growth in the remaining regions of the casing.

In a further embodiment a strip-shaped support material having a predetermined width is first formed to a tube, for example using a forming shoulder. In this case the tube, to maintain its shape and to avoid a shrinkage on drying, can be charged with supporting air or be kept in its round shape using caliber support rings. For fixing the support material formed into a tube, the support strip, for example by means of a sticky finger, is stuck together with blood plasma, protein, gelatin, collagen etc. and the support material is subsequently coated from the inside and/or outside “seamlessly” with the coating mix, for example using a ring slot die. The seam area of this casing is then only insignificantly thicker than the remaining regions. The working steps cutting and gluing coated strips are not necessary in this embodiment.

Alternatively thereto, casings having a longitudinal seam may be obtained by cutting open a large-caliber tube in the longitudinal direction and dividing the cut-open tube into parallel strips. The gluing of the resultant flat strips proceeds as described above. Casings produced in this manner have a particularly uniform extension over the entire periphery.

Casings having a natural sausage-skin-like shape or another irregular shape may be obtained by an appropriate cut of the flat strips. They then have, for example, a changing diameter and/or irregular contours. The longitudinal edges of these casings having special shapes are glued in the manner described using the proteinaceous glue.

If desired, the food casing of the invention can additionally be enclosed by a net. Such nets are generally known. They comprise, for example, honeycomb-shaped, octagonal, square or rectangular structures. They can also be elastic.

The casing of the invention may be stuffed using the conventional stuffing machines with pasty foods, in particular with sausagemeat emulsion. In the use as sausage casing they are expediently used in shirred form (as what is termed a shirred stick) or in the form of individual sections. The individual sections in this case are closed at one end, for example by a metal or plastic clip, by tying off yarn or by stitching. The sections are then individually pushed onto the stuffing horn of the stuffing device, stuffed with sausagemeat emulsion and closed. Further processing can then proceed as customary by scalding, boiling, smoking, ripening etc.

Part of the present invention is accordingly also the use of the casing of the invention as artificial sausage casing, in particular for raw sausage, scalded-emulsion sausage, or cooked-meat sausage, or as coating for cheese.

The examples hereinafter serve to illustrate the invention. Percentages are percentages by weight, where not stated otherwise, or is clear from the context.

### EXAMPLE 1

A nonwoven fabric of hemp fibers having a weight per unit area of 19 g/m² was coated with gelatin. The total weight was 88 g/m². The flat strip was formed by gluing with gelatin to form a tube having a diameter of 40 mm (= caliber 40). The gluing proceeded with gelatin which was dried, under the action of heat. The casing was stuffed with a salami emulsion and smoked. After a sausage ripening time of 10 days, the weight loss was 20%. The glued seam was transparent and not visible. Over the entire periphery of the sausage, the smoke transfer was uniform.

### EXAMPLE 2

A woven textile fabric made of a cotton/polyester mixture having a weight of 102 g/m² was coated with a butyl acrylate resin and glued with protein to form a tubular casing having a diameter of 60 mm. A stable glued, seam was achieved by coagulating the protein at 85° C. The casing was stuffed with salami emulsion and smoked with hot smoke. After a ripening time of 18 days, the weight loss was 18%, the smoke permeability was uniform over the entire periphery of the casing.

### EXAMPLE 3

A nonwoven fabric made of hemp fibers having a weight per unit area of 25 g/m² was coated with collagen. The total weight was 104 g/m². The flat strip was formed by gluing with blood plasma to give a tube having a diameter of 50 mm. The resultant casing was stuffed with a salami emulsion and ripened by mold ripening. After a sausage ripening time of 20 days, a weight loss of 22% resulted. Over the periphery and over the glued seam an absolutely uniform mold growth occurred. No difference between seam and periphery was observable in this case, as was required by the sausage manufacturers.

### EXAMPLE 4

A woven textile fabric having 100% viscose staple having a weight per unit area of 58 g/m² was coated using doctorknife application with colorless viscose and subsequently regenerated to give cellulose. The flat strip was glued with protein to form a casing. The casing was stuffed with coarse Teewurst. Subsequently the sausage was cold smoked. After a ripening time of 6 days, the glued seam could no longer be distinguished from, the periphery of the casing, and the smoke transfer was absolutely uniform over the entire periphery of the sausage.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

As used herein and in the following claims, articles such as “the”, “a” and “an” can connate the singular or plural.

All documents referred to herein are specifically incorporated herein by reference in their entireties.

We claim:

1. A smoke-permeable, tubular food casing comprising, in a longitudinal direction, a smoke-permeable glued seam generated front adhesive comprising in the dry state 10 to 100% by weight of protein.

2. The food casing as claimed in claim 1, wherein the adhesive is generated from adhesive comprising in the dry state 50 to 95% by weight of protein.

3. The food casing as claimed in claim 1, wherein the protein in the adhesive is blood plasma, collagen, gelatin, casein, soy protein, gluten, zein, ardein, pea protein, cottonseed or fish protein, protein from mussels, algae, fungae or other biomaterials from marine creatures or a mixture thereof.

4. The food casing as claimed in claim 1, wherein the adhesive, in addition to protein, also comprises at least one other glue of natural or synthetic origin.

5. The food casing as claimed in claim 4, wherein the glue of synthetic origin is a poly(meth)acrylate.

6. The food casing as claimed in claims 1, wherein the casing comprises cellulose or a film-forming protein.

7. The food casing as claimed in claims 6, wherein the film-forming protein is collagen.

8. The food casing as claimed in claim 1, wherein the casing is reinforced by a flat insert.

9. The food casing as claimed in claim 8, wherein the flat insert is a consolidated nonwoven or spunbonded nonwoven, a woven fabric, loop-formingly knitted fabric, loop-drawingly knitted fabric, laid fabric or a porous film.

10. The food casing as claimed in claim 8, wherein the flat insert comprises natural and/or synthetic fibers, regenerated cellulose, silk, polyester, polyamide, polyolefin, poly(vinyl acetate), polyacrylonitrile, poly(vinyl chloride), a corresponding copolymer or a mixture thereof.

11. The food casing as claimed in claim 8, wherein the flat insert is impregnated.

12. The food casing as claimed in claim 8, wherein the flat insert has a weight of 3 to 400 g/m².

13. The food casing as claimed in claim 8, wherein the casing comprises coating and the coating comprises a film-forming protein, a natural or synthetic polymer or cellulose or mixtures thereof.

14. The food casing as claimed in claim 13, wherein the synthetic polymer is a polyacrylate, poly(vinyl acetate) and/or a (co)polymer having units of vinyl acetate and/or units of saponified vinyl acetate.

15. The food casing as claimed in claim 6, wherein the fraction of film-forming protein is 2.5 to 95% by weight based on the dry weight of the casing.

16. The food casing as claimed in claim 13, wherein the fraction of film-forming protein is 2.5 to 95% by weight based on the dry weight of the casing.

17. The food casing as claimed in claim 6, wherein the casing comprises at least one compound which crosslinks the film-forming protein and as a result reduces or eliminates its water solubility.

18. The food casing as claimed in claim 13, wherein the coating comprises at least one compound which crosslinks the film-forming protein and as a result reduces or eliminates its water solubility.

19. The food casing as claimed in claim 17, wherein the compound which crosslinks the film-forming protein is an epoxidized linseed oil, a diketene having (C₁₀-C₁₈)alkyl radicals, caramel, tannin, a diepoxide, citral, an aziridine, glyoxal, glutaraldehyde and/or a polyamine-polyamide epichlorohydrin resin.

20. The food casing as claimed in claim 18, wherein the compound which crosslinks the film-forming protein is an epoxidized linseed oil, a diketene having C₁₀-C₁₈)alkyl radicals, caramel, tannin, a diepoxide, citral, an aziridine, glyoxal, glutaraldehyde and/or a polyamine-polyamide epichlorohydrin resin.

21. The food casing as claimed in claim 1, wherein the casing comprises dyes and/or pigments in an amount of 0.5 to 12.0% by weight based on the dry weight of the casing.

22. The food casing as claimed in claim 1, wherein the casing is impregnated internally and/or externally with agents which serve for setting the sausagemeat emulsion adhesion or improving mold resistance and/or with agents which serve as transferable dyes, aroma substances, odor substances and/or taste substances.

23. The food casing as claimed in claim 1, wherein the casing has a regularly or irregularly changing diameter and/or a regularly or irregularly changing contour.

24. The food casing as claimed in claim 1, wherein the casing is processed to give cut-off sections, tied-off sections or shirred sticks.

25. The food casing as claimed in claim 1, wherein the casing is enveloped by a net which comprises honeycomb-shaped, octagonal, square and/or rectangular structures and optionally is elastic.

26. A process for producing the food casing as claimed in claim 1, which comprises either
a) shaping a flat support material having a predetermined width to form a tube,
b) optionally charging the tube with supporting air to maintain its shape or maintaining the tube in its round shape with caliber support rings,
c) gluing the support material with a proteinaceous adhesive and
d) subsequently coating the support material internally and/or externally with a continuous coating, or
a′) furnishing a flat support material on one or both sides with the coating and the coated support material optionally is cut into strips of appropriate width,
b′) shaping the coated support material or strips obtained therefrom to form a tube having overlapping longitudinal edges and
c′) firmly binding the overlapping longitudinal edges to one another by gluing.
